(19) United States
(12) Patent Application Publication
(10) Pub. No.: US 2003/0153670 A1
(43) Pub. Date: Aug. 14, 2003

(54) Reinforced polyamide with improved thermal ageing properties

(76) Inventors: Dirk Pophusen, Gladbach (DE); Stefanie Klingelhofer, Krefeld (DE); Detlev Joachimi, Krefeld (DE); Cliff Scherer, Schwalmtal (DE); Helmut Schulte, Krefeld (DE); Karsten Idel, Krefeld (DE)

Correspondence Address: BAYER POLYMERS LLC, 100 BAYER ROAD, PITTSBURGH, PA, 15205, US

(21) Appl. No.: 10/275,422

(22) PCT Filed: Apr. 30, 2001
(86) PCT No.: PCT/EP01/04846

(30) Foreign Application Priority Data
May 8, 2000 (DE) 10022144.0

(51) Int. Cl. C08K 3/34; C08K 3/40

(52) U.S. Cl. 524/445; 524/494

(57) ABSTRACT

The invention relates to moulding materials, comprising 60 to 90 parts by weight polyamide, 10 to 40 parts by weight reinforcing materials (except for nanoscale layered silicates) and 0.5 to 6 parts by weight nanoscale layered silicates.

The invention relates to moulding compositions containing from 60 to 90 parts by weight polyamide, from 10 to 40 parts by weight reinforcing agents (with the exception of nano-scale layered silicates) and from 0.5 to 6 parts by weight nano-scale layered silicates.

Within the framework of attempts to achieve a reduction in the fuel consumption of motor vehicles by reducing their weight, conventional metallic materials in parts of motor vehicles that carry or store fuel or other media are being replaced by “lighter” materials having lower specific densities and, especially, by plastics. In order to ensure a similar level of mechanical properties, such plastics in technical components that are exposed to mechanical and thermal stresses are in most cases reinforced by fibres or mineral fillers. Typical applications are, for example, tubes and pipes for transporting fuel, oil-pans and induction manifolds.

For “under the bonnet” applications, the mechanical properties of the materials that are used must have a high degree of stability towards the temperatures and media that occur there. Such demands exist in particular also as long-term demands over the entire working life of a vehicle. Particular attention is drawn here to serviceability at temperatures of approximately 130° C. and periods of time of 3000 hours under the influence of media, such as, for example, when storing glycol/water. The polyamides conventionally employed frequently exhibit too marked a deterioration in strength under such conditions.

In addition, the polyamides used hitherto for such applications have deficiencies in respect of the permeation of hydrocarbons. Hydrocarbons (HC's) are widely used in the automotive sector. On the one hand they are used as fuels, for example in the form of benzines, and on the other hand they are found as other media, for example in the form of lubricants as oils. Against the background of increased demands as regards the maximum emissions of HC's, the object was to develop a polyamide material that satisfies the mechanical and thermal demands and that has an improved barrier against HC's.

In closed-loop cooling systems, coolant temperatures of 130° C. at pressures of 2 bar in the coolant-saturated state require the material to have a high degree of mechanical strength and tightness in order for the cooling system to function. In the automotive sector, the coolant is in most cases a 1:1 mixture of ethylene glycol and water.

The use of heat-stabilised, glass-fibre-reinforced polyamide (PA) for applications in the automotive sector, especially in the engine compartment, is known. The polyamides used thereby are especially PA 6 and PA 66. PA 66 is especially suitable owing to its higher dimensional stability under heat. In order to comply with the various demands, the polyamides are often modified. According to the specification required, the materials are heat-stabilised, elastomer-modified and accordingly particularly impact resistant, stable to hydrolysis or exhibit reduced water absorption (R. Zimnol, Kunststoffe 88 (1998) 5, p. 690-694, Carl Hanser Verlag, Munich).

EP-A 0 358 415 describes a polyamide moulding composition having improved barrier properties against gases and fluids, which moulding composition contains uniformly distributed layered silicate. These layered silicates have a lateral length of from 0.002 to 1 μm and a thickness of from 6 to 20 Å.

U.S. Pat. No. 5,248,720 describes a process for the production of a polyamide moulding composition containing layered silicates. Such moulding compositions exhibit an improved barrier against gases, while having good mechanical and thermal properties, and are used in pipe and storage systems for fuels.

JP-A 11 228 817 describes a polyamide moulding composition having low oxygen permeability and containing layered silicates. Such moulding compositions are to be used as petrol tanks and tubes, filters etc. for fuel pipes.

EP-A 0 810 260 and EP-A 0 810 259 describe a film or a moulding of polyamide containing nano-disperse fluoromica. The advantage of such moulding compositions is that they have an improved oxygen barrier. The optical and mechanical properties are retained. Such moulding compositions are used as tubes and tanks for benzines and oils.

A disadvantage of the moulding compositions is a poor thermal-ageing resistance when storing glycol/water.

The object of the invention was to provide a reinforced polyamide-based moulding composition which, as compared with the prior art, has improved thermal-ageing behaviour when storing glycol/water and which, additionally, has an improved barrier against hydrocarbons, without exhibiting a significant deterioration in the other mechanical and thermal properties as compared with the reinforced polyamide materials used today.

Surprisingly, it has been found that the incorporation of nano-scale layered silicates into reinforced polyamide moulding compositions leads to a markedly improved thermal-ageing resistance when storing glycol/water and, additionally, to an increased barrier against hydrocarbons.

The application provides moulding compositions containing polyamide, reinforcing agents and nano-scale layered silicates. Preference is given to moulding compositions containing from 60 to 90 parts by weight polyamide, from 10 to 40 parts by weight reinforcing agents (with the exception of nano-scale layered silicates) and from 0.5 to 6 parts by weight nano-scale layered silicates.

The moulding compositions may be produced by incorporating the layered silicates during the polymerisation or by incorporating the reinforcing agents subsequently by compounding in an extrusion process.

The production specifications may be found, for example, in DE-A 199 48 850.

The layered silicate according to the invention is a natural or synthetic swellable layered silicate. Typical representatives of swellable layered silicates for this application are, for example, montmorillonite and hectorite.

Preference is given to the use of so-called organoclays, in which the surfaces have been modified by ion exchange with organic components (e.g. quaternary ammonium compounds). Such organoclays are described, for example, in patent specifications DE-A 3 632 865 and DE-A 3 808 623. The mentioned specifications form part of the disclosure. The layered silicates mentioned in DE-A 3 632 865 and DE-A 3 808 623 have a thickness of from 0.7 to 1.2 nm.

Further typical representatives are synthetic fluoromicas. Such fluoromicas are described, for example, in DE-A 196 21 309.

After incorporation into the polyamide matrix, the majority of the particles have an edge length<1 μm and a layer thickness of from 0.5 to 2 nm.

Particularly preferred layered silicates are montmorillonite, hectorite, synthetic fluoromicas.

The addition of the layered silicates according to the invention may be carried out before, during or after the polymerisation of the monomers to form the polyamide. If the addition of the layered silicates according to the invention is carried out after the polymerisation, then it is preferably effected by addition to the polyamide melt in an extruder. If the addition of the layered silicates according to the invention is carried out before or during the polymerisation, then the polymerisation may include phases in which the operation is carried out in the presence of from 1 to 50 wt. % water.

The moulding compositions contain further fibrous reinforcing agents and/or mineral fillers; in addition to glass fibres, carbon fibres, aramid fibres, mineral fibres and whiskers may also be considered. Examples of suitable mineral fillers which may be mentioned are calcium carbonate, dolomite, calcium sulfate, micas, fluoromicas, wollastonite, talcum and kaolin. However, it is also possible to use other oxides or oxide hydrates of an element selected from the group boron, aluminium, gallium, indium, silicon, tin, titanium, zirconium, zinc, yttrium and iron. In order to improve the mechanical properties, the fibrous reinforcing agents and the mineral fillers may be surface-treated.

The addition of the fillers may be carried out before, during or after the polymerisation of the monomers to form the polyamide. If the addition of the fillers according to the invention is carried out after the polymerisation, then it is preferably carried out by addition to the polyamide melt in an extruder. If the addition of the fillers according to the invention is carried out before or during the polymerisation, then the polymerisation may include phases in which the operation is carried out in the presence of from 1 to 50 wt. % water.

When the fillers are added, they may already be in the form of particles having the particle size ultimately occurring in the moulding composition. Alternatively, the fillers may be added in the form of preliminary stages, from which the particles ultimately occurring in the moulding composition are formed only in the course of the addition or incorporation. Such preliminary stages may contain auxiliary substances which serve, for example, to stabilise the preliminary stage or to ensure that the particles are distributed finely in the moulding composition. Such auxiliary substances may be, for example, surface-modifying agents.

Particularly preferred reinforcing agents are glass fibres.

Suitable polyamides are known homopolyamides, copolyamides and mixtures of such polyamides. They may be semi-crystalline and/or amorphous polyamides.

Suitable semi-crystalline polyamides are polyamide-6, polyamide-6,6, mixtures and corresponding copolymers of those components. Semi-crystalline polyamides, the acid component of which consists wholly or partially of terephthalic acid and/or isophthalic acid and/or suberic acid and/or sebacic acid and/or azelaic acid and/or adipic acid and/or cyclohexanedicarboxylic acid, and the diamine component of which consists wholly or partially of m- and/or p-xylylene-diamine and/or hexamethylenediamine and/or 2,2,4-trimethylhexamethylenediamine and/or 2,4,4-trimethylhexamethylenediamine and/or isophoronediamine, and the composition of which is in principle known, may also be considered.

Mention may also be made of polyamides which are prepared wholly or partially from lactams having from 7 to 12 carbon atoms in the ring, optionally with the concomitant use of one or more of the above-mentioned starting components.

Particularly preferred semi-crystalline polyamides are polyamide-6 and polyamide-6,6 and mixtures thereof. Known products may be used as amorphous polyamides. They are obtained by polycondensation of diamines, such as ethylenediamine, hexamethylenediamine, decamethylenediamine, 2,2,4- and/or 2,4,4-trimethylhexamethylenediamine, m- and/or p-xylylene-diamine, bis-(4-aminocyclohexyl)-methane, bis-(4-aminocyclohexyl)-propane, 3,3′-dimethyl-4,4′-diamino-dicyclohexylmethane, 3-aminomethyl-3,5,5-trimethylcyclohexylamine, 2,5- and/or 2,6-bis-(aminomethyl)-norbornane and/or 1,4-diaminomethylcyclohexane, with dicarboxylic acids, such as oxalic acid, adipic acid, azelaic acid, decanedicarboxylic acid, heptadecanedicarboxylic acid, 2,2,4- and/or 2,4,4-trimethyladipic acid, isophthalic acid and terephthalic acid.

Also suitable are copolymers obtained by polycondensation of several monomers, and copolymers prepared with the addition of aminocarboxylic acids, such as -aminocaproic acid, -aminoundecanoic acid or -aminolauric acid or their lactams.

Particularly suitable amorphous polyamides are the polyamides prepared from isophthalic acid, hexamethylenediamine and further diamines, such as 4,4′-diamino-dicyclohexylmethane, isophoronediamine, 2,2,4- and/or 2,4,4-trimethylhexamethylenediamine, 2,5- and/or 2,6-bis-(aminomethyl)-norbornene; or from isophthalic acid, 4,4′-diamino-dicyclohexylmethane and -caprolactam; or from isophthalic acid, 3,3′-dimethyl-4,4′-diamino-dicyclohexylmethane and laurinlactam; or from terephthalic acid and the isomeric mixture of 2,2,4- and/or 2,4,4-trimethylhexamethylenediamine.

Instead of pure 4,4′-diaminodicyclohexylmethane, it is also possible to use mixtures of the position-isomeric diaminodicyclohexylmethanes, which are composed of

| | |
|---|---|
| from 70 to 99 mol % | of the 4,4′-diamino isomer |
| from 1 to 30 mol % | of the 2,4′-diamino isomer |
| from 0 to 2 mol % | of the 2,2′-diamino isomer, |

optionally corresponding to more highly condensed diamines, which are obtained by hydrogenation of commercial-grade diaminodiphenylmethane. Up to 30% of the isophthalic acid may be replaced by terephthalic acid.

The polyamides preferably have a relative viscosity (measured on a 1 wt. % solution in m-cresol at 25° C.) of from 2.0 to 5.0, particularly preferably from 2.5 to 4.0.

Processing of the moulding compositions according to the invention to mouldings is usually carried out by means of conventional injection-moulding machines or alternatively by blow-moulding devices.

The mouldings produced from the moulding compositions according to the invention are used as pipe or storage systems for hydrocarbon-containing fuels or other media in machines and equipment such as, for example, oil-pans, cooling water tanks, filter housings and induction manifolds, where they are subjected to mechanical and thermal stresses.

The application relates also to the use of the moulding compositions according to the invention in the production of moulded bodies such as, for example, pipe systems for fuels and other media, preferably in the automotive sector, storage systems such as, for example, oil tanks.

Moulded bodies produced from the moulding compositions according to the invention are also provided.

Production may be carried out, for example, by extrusion and/or injection-moulding processes, blow-moulding processes, thermoforming processes and special processes (GIT), especially for the production of tubes and hollow bodies.

### EXAMPLES

### Preparation of the Thermoplastic Moulding Compositions According to the Application and of Comparative Moulding Compositions

### Example 1

Polyamide 66 (relative viscosity η_{rel.}=3.0, 0.5 wt. % solution in m-cresol) was compounded in a twin-screw extruder from Werner & Pfleiderer (150 rpm; 10 kg/h) at 300° C. with 5 wt. % of an organically modified montmorillonite (SCPX 1127-A, Southern Clay, USA, tallow fatty acid methyl-bis-(2-hydroxyethyl)-ammonium chloride as modifier), 30 wt. % glass fibres (P955; Vetrotex), 0.16 wt. % montan ester wax, 0.1 wt. % carbon black and 0.13 wt. % heat stabiliser, extruded into a water bath and granulated.

### Example 2

In an analogous manner, PA66 was compounded with identical amounts of additives and glass fibres without organically modified montmorillonite, extruded into a water bath and granulated.

### Example 3

PA 6 (Durethan® B29, Bayer AG, Leverkusen, Germany, relative viscosity η_{rel.}=2.9, 0.5 wt. % solution in m-cresol) was compounded in a twin-screw extruder from Werner & Pfleiderer (100 rpm; 10 kg/h) at 260° C. with 2.7 wt. % of an organically modified montmorillonite (Nanomer I24T, Nanocor, USA, ω-aminododecanoic acid as modifier), 30 wt. % glass fibres (P 955, Vetrotex), 0.16 wt. % montan ester wax, 0.1 wt. % carbon black and 0.13 wt. % heat stabiliser, extruded into a water bath and granulated.

### Example 4

In an analogous manner, PA6 (Durethan® B 29) was compounded with identical amounts of additives and glass fibres without organically modified montmorillonite, extruded into a water bath and granulated.

### Example 5

In an autoclave, a mixture of 8736 g of caprolactam, 1001, 1 g of aminohexanoic acid and 400 g of an organically modified hectorite (EA-2533, Rheox Inc., USA, tetrakis(2-hydroxyethyl)ammonium chloride as modifier) was stirred for 2 hours at 90° C. under nitrogen. The mixture was then warmed to 220° C. and stirred for a further one hour at that temperature, then the mixture was heated to 270° C. and again stirred for one hour, before the material was spun off. After extraction and drying, the material was compounded in a twin-screw extruder from Werner & Pfleiderer (100 rpm; 10 kg/h) at 260° C. with 30 wt. % glass fibres (CS7928, Bayer AG), 0.16 wt. % montan ester wax, 0.1 wt. % carbon black and 0.13 wt. % heat stabiliser, extruded into a water bath and granulated.

Tests for Assessment of the Moulding Compositions

Measurement of Fuel Permeation

Determination of fuel permeation was carried out on round disks having a thickness of 2 mm and a diameter of 90 mm, which had been prepared from injection-moulded rectangular sheets 150×105×2 mm³.

In order to determine the fuel permeation, the weight loss of the measuring cell described below caused by permeation of the fuel at 40° C. was recorded over time. The permeation value is determined in the range of stationary weight loss.

The measuring cell is a vessel which is open on one side and has valve connections for aeration and for introduction of the fuel. The open side of the vessel is closed by means of a seal with the described round disk of the moulding composition according to the application. After closing of the apparatus, the temperature is adjusted to 40° C. and, at that temperature, the test fuel adjusted to a temperature of 40° C. is introduced without pressure (that is to say with the aeration valve open).

The test fuel used was a mixture according to DIN 51604 B/2, which has the following composition (in each case vol. %):

| | |
|---|---|
| toluene | 42.25% |
| isooctane | 25.35% |
| diisobutene | 12.67% |
| ethanol | 4.23% |
| methanol | 15.0% |
| water | 0.5%. |

Measurement of Thermal-Ageing Resistance

In order to assess thermal ageing, the change in IZOD impact strength according to ISO 180 1U was determined. To that end, the test specimens were stored in an autoclave at 130° C. in a 1:1 (vol.) mixture of ethylene glycol/water. The results for a material were related to the initial value, in order to emphasise the effect caused by ageing.

The results from Table 1 confirm that the moulding compositions according to the invention, as compared with moulding compositions without nano-scale layered silicates, exhibit both a marked improvement in the barrier function against fuel and slower thermal ageing when stored in the ethylene glycol/water mixture, irrespective of whether the nano-scale layered silicates are added during the polymerisation or are incorporated by compounding.

TABLE 1

| | | Example | Example 2 | Example | Example 4 | Example |
|---|---|---|---|---|---|---|
| | | 1 | (comparison) | 3 | (comparison) | 5 |
| PA 66 | % | 64.61 | 69.61 | — | — | — |
| PA 6 | % | — | — | 66.91 | 69.61 | 66.91 |
| Layered | % | 5 | — | 2.7 | — | 2.7 |
| silicate¹⁾ | | | | | | |
| Glass | % | 30 | 30 | 30 | 30 | 30 |
| fibres | | | | | | |
| Propety | | | | | | |
| Impact | | | | | | |
| strength | | | | | | |
| ISO 180 | | | | | | |
| 1U after | | | | | | |
| 0 d | % | 100³⁾ | 100⁴⁾ | 100⁵⁾ | 100⁶⁾ | 100⁷⁾ |
| 7 d | % | 126 | 115 | 122 | 64 | 99 |
| 14 d | % | — | — | 50 | 39 | 44 |
| 21 d | % | 84 | 73 | 28 | 20 | 23 |
| 42 d | % | 37 | 29 | — | 9 | — |
| Fuel | g/(m²d) | 7.2 | 11.1 | 6.6 | 12.6 | 5.6 |
| permeation | | | | | | |

¹⁾SCPX1127-A, Example 1; Nanomer I24T, Example 3; EA-2533, Example 5
²⁾0.16 wt. % montan ester wax, 0.1 wt. % carbon black, 0.13 wt. % heat stabiliser
³⁾Initial value: 61.6 kJ/m²
⁴⁾Initial value: 65.4 kJ/m²
⁵⁾Initial value: 32.0 kJ/m²
⁶⁾Initial value: 70.0 kJ/m²
⁷⁾Initial value: 54.1 kJ/m²

1. Moulding compositions containing from 60 to 90 parts by weight polyamide, from 10 to 40 parts by weight reinforcing agents (with the exception of nano-scale layered silicates) and from 0.5 to 6 parts by weight nano-scale layered silicates.

2. Moulding compositions according to claim 1, wherein the layered silicate used is montmorillonite, hectorite and/or synthetic fluoromica.

3. Moulding composition according to one or more of the preceding claims, wherein the reinforcing agents used are glass fibres.

4. Use of the moulding compositions according to one or more of the preceding claims in the production of moulded bodies.

5. Use according to claim 4, wherein moulded bodies are pipe systems for fuels and other media and/or storage systems.

6. Moulded bodies produced according to one or more of the preceding claims.

7. Pipe systems for fuels and other media and/or storage systems, produced according to one or more of the preceding claims.
